(19) United States
(12) Patent Application Publication
(10) Pub. No.: US 2007/0079536 A1
(43) Pub. Date: Apr. 12, 2007

(54) Ultrasonic or heat staking attachment or plant tag

(76) Inventor: Walter J. Hall, Canton, OH (US)

Correspondence Address: HAHN LOESER & PARKS, LLP, One GOJO Plaza, Suite 300, AKRON, OH, 44311-1076, US

(21) Appl. No.: 11/549,051

(22) Filed: Oct. 12, 2006

Related U.S. Application Data
(60) Provisional application No. 60/725,821, filed on Oct. 12, 2005.

(51) Int. Cl. G09F 3/10

(52) U.S. Cl. 40/299.01

(57) ABSTRACT

The present invention relates to affixing identification tags to a container. More specifically, the present invention relates to affixing a plastic identification tag to a plant container using ultrasonic welding and/or heat staking. A plastic stud may exist that extends from either the tag or the container through a hole or recess in the other of the tag or container. The stud is then deformed via ultrasonic welding or heat staking to secure the tag to the container. The tag may be affixed without the use of a stud via ultrasonic welding and/or heat staking.

This application claims priority to provisional application Ser. No. 60/725,821, filed Oct. 12, 2005, the disclosure of which is hereby incorporated by reference.

### BACKGROUND

Plant identification tags are a convenient method, and perhaps even a necessity, in terms of identifying sundry plants in whatever setting they may be available for sale. These tags certainly reduce consumer frustration, and save employees from the daunting task of remembering all the information associated with the potential multitude of a proprietor's displayed plants. Plant tags come in various shapes and sizes, but contain the same basic plant identifying information, which of course changes with the specific plant. Many tags contain a tapered lower end for inserting in a container slit or directing into the planting medium. Typically, the front of a tag lists the plant's common and scientific names and summarizes key information about it. An accompanying close-up color photo commonly shows the plant's flowers and foliage as they appear at maturity. The reverse side of the tag is usually devoted to more specific details on how to transplant and care for the plant, or it might provide specific features and favored uses of the plant.

Currently most proprietors place plant identification tags into a slit within the pot, stick the tag into the plant media surrounding the plant, or attach the tag directly to the plant. Often this requires a more complicated and thus potentially more expensive pot design and/or pot manufacture. Further, whether the identification tag is placed in a slit, in the plant media, or on the plant, it can be readily removed. Currently, this is a disadvantage because a dishonest consumer has the ability to quickly exchange tags from a less expensive plant to the desired more expensive plant. In such a scenario, other consumers can potentially be affected by unwittingly purchasing the wrong plant at a higher than marketed price. Moreover, the store's profits can be negatively affected, and unfortunately, that store might seek to shield its profits and mitigate such potential losses, by passing them on to all its future customers in the form of higher prices. Some consumers might even blame the store for unscrupulously misrepresenting its products. Often, these stores may be forced to accept such blame and its associated negativity, particularly if they are unaware of the true source of the error. Still further, easily removable tags make inventory management, security, and logistics/shipment tracking more difficult. Finally, providing a container with loose or easily removable tag prevents the container supplier from fulfilling a customer's desire to obtain a durable and integrated plant-identifying container.

Additionally, directing the pointed end associated with many plant tags, into the plant's media, has the potential to damage the plant's roots. In addition, placing a tag on the plant itself, adds an unwelcome and unnecessary load. This can also burden a fragile plant and produce needless damage.

As such, one solution would be to attach identification tags directly to plant containers. When so attached, tags cannot be readily removed. Therefore, there is a need to provide an effective, efficient, system that allows consumers to accurately and confidently identify plants and/or flowers before making a purchase. The foregoing illustrates some conditions and limitations known to exist in the present garden store environment. Thus, it is apparent that it would be advantageous to provide an alternative directed to overcoming one or more of the limitations set forth above. Accordingly, a suitable alternative is provided including features more fully disclosed hereinafter.

### SUMMARY

In a first embodiment, the present invention provides a plant identifying tag comprising: a first surface and a second surface; and, a plastic container-securing stud extending from the first surface.

In a second embodiment, the present invention provides a plant identifying container comprising: a plant container; and, a plant identifying tag, wherein the container and tag each have an engaging element for securing the tag to the container, one engaging element comprising a plastic projection and the other engaging element comprising a void, the projection engaging the void and being deformed to resist disengagement.

In a third embodiment, the present invention provides a method of providing a plant identifying container comprising the steps of: providing a plant container; providing a plant tag; and, applying ultrasonic energy or heat to attach the tag to the container.

### BRIEF DESCRIPTION OF THE DRAWINGS

The accompanying drawings, wherein identical parts are identified with identical reference numerals are intended to facilitate an understanding of the concept described thereafter:

FIG. 1 shows a perspective view of a typical plastic plant container;

FIG. 2 shows a front view of a plant identification tag suitable for use with the present attachment method;

FIG. 3 shows an underside view of a plant identification tag suitable for use with the present attachment method;

FIG. 4 shows a perspective view of a plant identification tag affixed to a plant container according to an embodiment of the present concept;

FIG. 5 shows a perspective view of a plant container with holes for inserting plant-identification-tag studs, as in one embodiment of the concept;

FIG. 6 shows a perspective exploded view of the plant container and studded plant identification tag consistent with an embodiment of the present invention; and,

FIG. 7 shows a cross-sectional view of tag secured to a container via a stud, consistent with the embodiment of FIG. 6.

### DESCRIPTION OF THE INVENTION

The following detailed description sets forth alternate embodiments for apparatuses and methods of affixing identification tags to containers, including, but not limited to, plastic identification tags and containers and plant identification tags and containers, such as, but not limited to, flats and pots. In one embodiment, the container is a plant container constructed of plastic materials, and more specifically in another embodiment of thermoform plastic; however, it may be constructed of any materials suitable for joining with the plant identification tag. This description should not be interpreted as limiting the use of the invention to this particular application. Further, reference is made to the accompanying pictures, diagrams, and/or figures, which, in conjunction with this detailed description, illustrate and describe the methods of affixing an identification tag to a plant container. The invention may be embodied in many different forms and should not be construed as limited only to the disclosed embodiments.

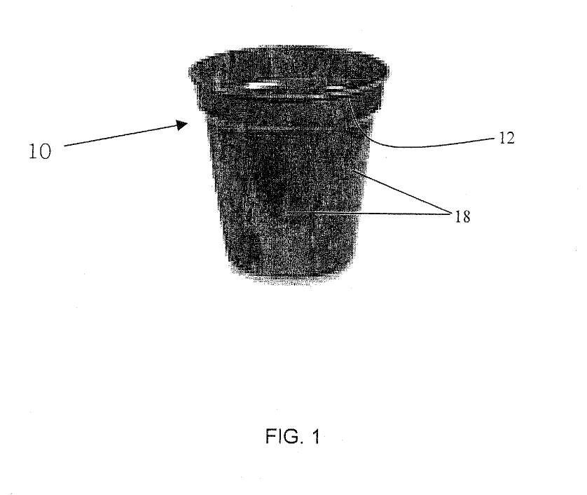

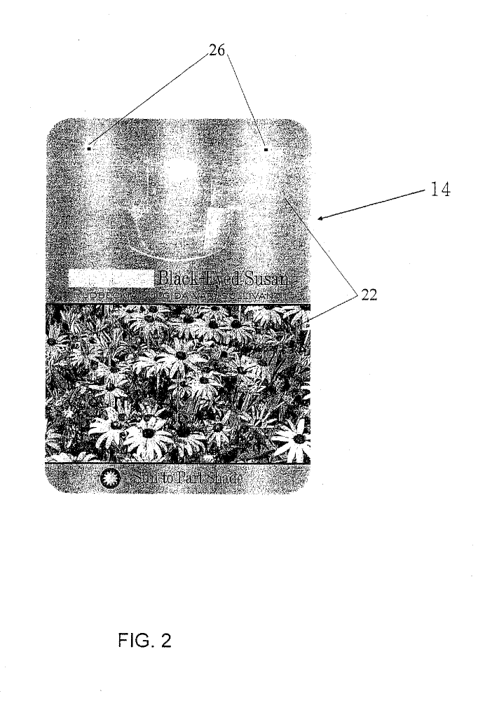

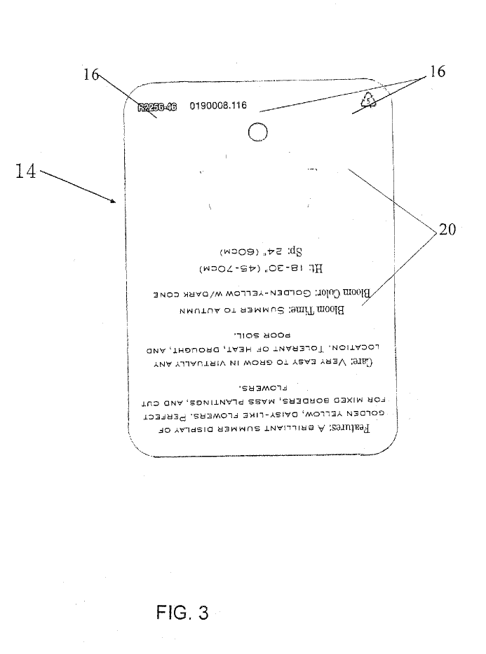

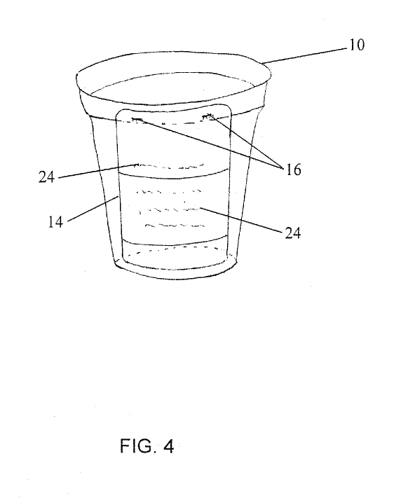

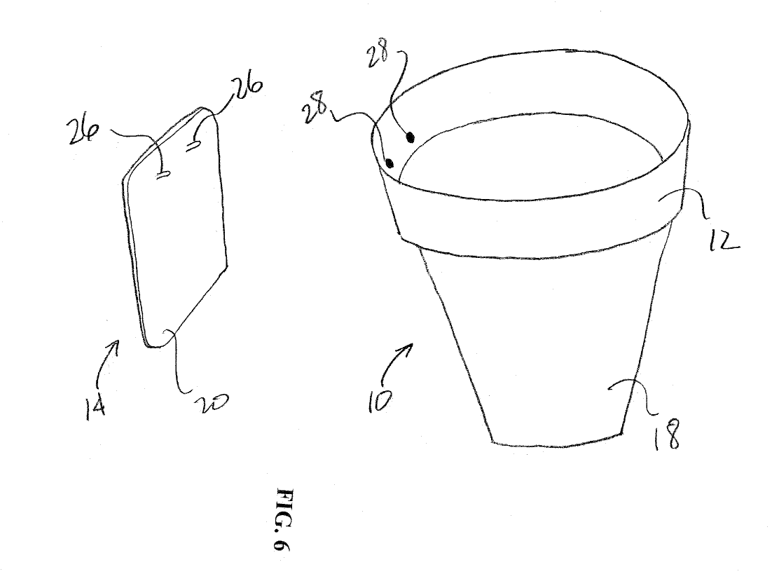

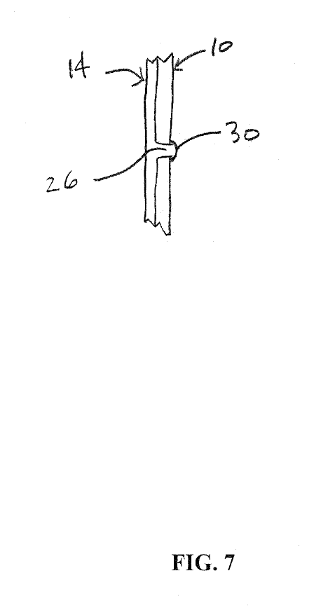

The present invention is shown in FIGS. 1-7. The present invention provides a typical plant container 10, which may or may not include an upper rim 12. Further, the present invention provides a plant tag 2 that will be suitable for attaching to plant container 10, and may have plant identifying indicia on either of or both of the front side 22 and the back side 20 of the tag 14. FIG. 2 shows the front side of a representative plant tag 14, while FIG. 3 shows the underside 20 of a representative plant identification tag 14. Such plant tags can generally be devoid of the usual tapered end or spade, and can be of any size or shape that can fit on container's 10 outer surface 18, with the functional constraint that its area must be less than the outer surficial area of the associated container 10. Tag 14 may include a radio frequency identification (RFID) tag or a barcode, either being located on the surface or within identification tag 14, for the purposes of improving inventory management, security, and/or logisitics/shipment tracking. The identification tag 14 can be positioned against the front side 22 or the back side 20 of the container 10. The tag 14 may or may not be attached to the rim 12 of the plant container 10. With the back side 20 of the tag 14 positioned against the outer surface of the container 10, the front side 22 of tag 14 and its plant and/or flower identifying information 24 will be visible. It is contemplated that other arrangements may be used, such as, but not limited to, attaching the tag 14 to an inside surface of container 10.

In one embodiment, the tag 14 may be affixed to the plant container 10 in this orientation using ultrasonic bonding (welding) and/or heat staking (collectively referred to as “staking”), or any other comparable plastic joining technique. Generally, ultrasonic bonding transmits ultrasonic pulses or waves, such as via a horn or probe, causing two adjacent plastic parts to vibrate. Although any frequency may be used, common frequencies typically range between 18 and 50 kHz. The vibration excites the atoms and/or molecules of the parts and generates heat, causing the respective parts to fuse together. Pressure may be applied to improve the bonding process. Consequently, the resulting join may comprise either or both of an atomic/molecular bond (hereinafter referred to collectively as a “chemical bond”) and a mechanical bond, each of which may be strengthened or otherwise improved by also deforming the bonding area during the staking process. A chemical bond is most easily generated between parts formed from similar plastics. As an alternative to ultrasonic energy, heat can be applied to the respective plastic parts to generate the same bond—which is called heat staking. Heat staking may be performed by using a compression probe, a horn, or any other device as required by the specific application. Ultrasonic welding is more easily controlled in that it can be better directed and limited to a certain desired area, in comparison to heat staking, which is more difficult to constrain in and direct to a certain area. Cycles times for ultrasonic staking may be 2.5 to 5 times less than heat staking. The use of heat and ultrasonic energy widens the application of staking to include a broader range of thermoplastic materials and glass-filled materials, which has not been possible with cold staking (which does not use heat). Staking also has the advantage that parts can be disassembled.

In another embodiment, ultrasonic bonding and heat staking may be used in conjunction with a stud 26 to provide an additional mechanical lock (interference fit) between the respective plastic parts. A stud 26 may be formed on one plastic component (on either or both of the tag 14 and the container 10), which is then inserted through a hole in a second plastic component. Subsequently, the stud 26 is deformed to form a head 30 on the side opposite the first component, thereby mechanically locking the two components together. The stud 26 may be molded or otherwise formed with the plastic component, or it may be added after the plastic part has already been formed. Moreover, a single operation may exist, where the stud 26 is formed and subsequently deformed into a head to join respective parts. After the stud 26 is inserted into a hole 28, staking (ultrasonic welding and/or heat staking) softens a portion of the stud. A user then deforms the stud 26 to form the head 30 by applying pressure to the stud 26 via the probe or horn. This formed head 30 provides a mechanical lock (or interference fit) between the plastic parts, which may be additional to any mechanical and/or chemical bond created between the parts via ultrasonic welding and/or heat staking techniques. Head 30 may be of any shape so long as it provides a shape that resists entry through the hole 28 (resists removal of the tag 14 from the container 10). It is also contemplated that the head 30 may not be located at the terminal end of the stud 26, and instead comprise any portion of the stud 26—meaning that an intermediate portion of the stud 26 may be deformed as described herein to resist removal of the tag 14 from the container 10. Heat staking provides the flexibility to allow the simultaneous formation of heads 30 on multiple studs 26 and to accommodate a variety of head/stud designs. The use of the stud 26 with the staking techniques identified above has the ability to join plastic to other materials, such as metal or to join dissimilar plastics. The choice of which staking process to use relates to the particular materials that require joining, the overall force to which the assembly will be subjected, and any required cosmetic appearance. One obvious advantage of this concept over mechanical joining methods, is the elimination of additional materials such as rivets and screws. It is also contemplated that the stud 26 may engage a recess in the container 10, whereby the ultrasonic welding or heat staking is used to form a head 30 by deforming both a portion of the recess and the stud, thereby joining the tag 14 to the container 10. The recess and the hole can be generally referred to as voids.

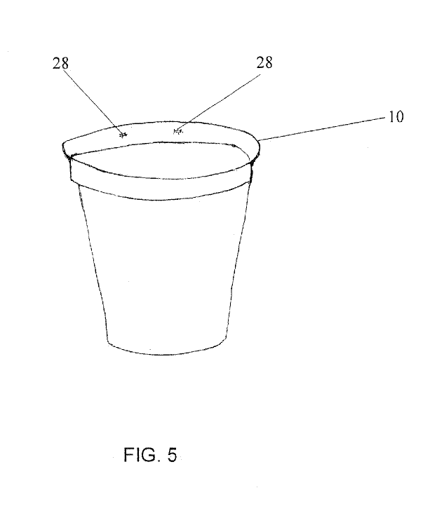

It is contemplated that one or more protruding studs 26 can be formed onto the identification tags and the stud(s) can be inserted into one or more corresponding holes 28 in the plant container. Alternatively, studs 26 can be formed onto the plant container 10 and thereafter inserted into the plant identification tag 14. The attachment locations, whether via staking or staking with studs, can be the point(s) 16 on the tag 14 within tag's upper portion, at back of tag 14. It is also contemplated that a single attachment point, most likely near the top central portion of tag, can be used, particularly if a relatively elongated stud is used. Nevertheless, two or more points, most likely distributed across the top portion of tag, will provide a more secure bond and reduce the chances of dislocation and the need for reattachment. The corresponding attachment location on the plant container 10 will be its upper portion or rim 12, at the location of holes 28, as shown in FIG. 5. A plastic tag 14 construction will allow for some malleability and the slight concave bending of tag 14 to conform to and accommodate the circular structure of a typical plant container 10. Of course, plant containers 10 may be of any shape, and its shape will have no bearing on the feasibility and manner of attachment. The described method of attachment will facilitate affixing tags 14 to containers 10, even when such containers are already occupied with dirt or a plant.

Applicant has contemplated alternate methods of conducting the steps required to form a completed product. It is contemplated that either the studding, hole formation, and bonding processes could be completed in close proximity in terms of time and location and as part of one process, or the formation of the studs, the introduction of the corresponding holes for fitting the studs, the later affixing, and/or any other required process(es), could be completed separately by incorporating each process into sequential or even simultaneous but separate in-line processes.

The present invention, in which identification tags are temporarily or permanently affixed to the plant container, will make it unnecessary to use pot slits, the surrounding plant media, or the plant itself, for inserting or attaching plant identification tags. In using ultrasonic or heat bonding or staking, the plant identification tags will be securely attached to the appropriate container. Moreover, in the present concept, the tags are designed for easy removal by the consumer, after purchase of the associated plant. Although these pre-attached tags can also be removed by in-store consumers, without any purchase, such consumers will have little incentive to do so because they will be unable to readily reattach the removed tag to another plant container. Moreover, consumers will easily recognize this lack of easy transferability between plants or plant containers.

Nevertheless, one might envision that if a cashier discovers a previously secured tag loosely stuck in the plant's surrounding dirt, such an employee will be expected to verify whether the loose tag is properly matched with the plant being purchased. Generally, due to the present design, there should not be a need for many reattachments, but a store could arrange to have any loose tags reattached either internally or via an external contractor. Since tags can be welded (staked) to the pot, with or without dirt or the plant inside, making such reattachments will not be burdensome.

Additionally, as in the case of the derived benefit of a less complicated pot design, plant identification tags that can be permanently affixed will be simpler to manufacture due to their lack of a tapered or spade portion that is usually required for inserting in the container slot, or in the enclosed dirt. Thus, due to its simpler design potential, we should expect tag manufacturer cost savings that can be passed on to retailers, and ultimately to consumers. Moreover, since tags can be attached directly to a plant pot, the present concept could facilitate the sale of specially designed pots and attached tags, that can be promoted as being best suited for a particular variety of plant, or specialized tag-pot combinations. Notably, many consumers save the tags that accompany plants as a valuable reference over many seasons as the plants grow and bloom. Some have even recommended the storing of tags in small picture albums. It should therefore be much easier to collect and store tags that do not possess an elongated spade feature, and/or where it is unnecessary to remove such a structure.

Further, securing plant identification tags to containers in accordance with this invention will facilitate and improve inventory management, security, and logistics/shipment tracking of the tagged containers (with or without plants). Also, plant container suppliers may now better meet customer fulfillment requirements by now having the capability to ship containers having secured identification tags.

To illustrate the invention, it is described with respect to specified embodiments. This is not intended as a limitation, and other modifications or variations to the specific apparatuses and methods described will be apparent to those skilled in the art and will fall within the spirit of the invention and the scope of the following claims.

What is claimed is:

1. A plant identifying tag comprising:
a first surface and a second surface; and,
a plastic container-securing stud extending from the first surface.

2. The plant tag recited in claim 1 further comprising:
a plant identification indicia emanating from the first and/or second surface.

3. The plant tag recited in claim 2, wherein the plant identification indicia is printed upon or formed within the first and/or second surface.

4. The plant tag recited in claim 1, wherein the plant tag is made of plastic.

5. The plant tag recited in claim 1, further comprising a second plastic container-securing stud extending from the first surface.

6. A plant identifying container comprising:
a plant container; and,
a plant identifying tag,
wherein the container and tag each have an engaging element for securing the tag to the container, one engaging element comprising a plastic projection and the other engaging element comprising a void, the projection engaging the void and being deformed to resist disengagement.

7. The plant identifying container recited in claim 6, wherein the void is a hole.

8. The plant identifying container recited in claim 6, wherein the projection is deformed by applying a force to plastic softened by ultrasonic energy or heat.

9. The plant identifying container of claim 8, wherein the application of ultrasonic energy or heat provides a chemical bond between the container and the tag.

10. The plant identifying container of claim 6, wherein the container is formed of plastic.

11. The plant identifying container of claim 6, wherein the tag is formed of plastic.

12. The plant identifying container of claim 6, wherein the tag and the container each have multiple engaging elements.

13. A method of providing a plant identifying container comprising the steps of:
providing a plant container;
providing a plant tag; and,
applying ultrasonic energy or heat to attach the tag to the container.

14. The method recited in claim 13, wherein the attached portion the container is formed of a first plastic and the attached portion of the tag is formed of a second plastic.

15. The method recited in claim 13, wherein the container and tag each have an engaging element for securing the tag to the container, one engaging element comprising a plastic projection and the other engaging element comprising a void, and the method further comprising the step of:
inserting the projection into the void,
wherein the step of applying energy or heat includes deforming a portion of the projection to resist removal of the projection from the void.

16. The method recited in claim 15, wherein the void is a hole and the deformed portion of the projection is a head that is shaped to resist passage through the hole.

17. The method recited in claim 15, wherein the container is formed of a first plastic and the tag is formed of a second plastic.

18. The method recited in claim 15, wherein the projection is formed integral with the tag.

19. The method recited in claim 13, wherein the application of ultrasonic energy or heat forms a chemical bond between a portion of the tag and a portion of the container.

20. The method recited in claim 15, wherein the container and tag each have multiple engaging elements.
